(19) United States
(12) Patent Application Publication
(10) Pub. No.: US 2007/0020519 A1
(43) Pub. Date: Jan. 25, 2007

(54) Anode active material, manufacturing method thereof and lithium battery using the anode active material

(76) Inventors: Han-su Kim, Seoul (KR); Seok-gwang Doo, Seoul (KR); Jae-phil Cho, Gumi-si (KR)

Correspondence Address: CHRISTIE, PARKER & HALE, LLP, PO BOX 7068, PASADENA, CA, 91109-7068, US

(21) Appl. No.: 11/481,657

(22) Filed: Jul. 5, 2006

(30) Foreign Application Priority Data
Jul. 5, 2005 (KR) 10-2005-0060301

(51) Int. Cl. H01M 4/60; H01M 4/38

(52) U.S. Cl. 429/213; 252/182.1; 429/218.1

(57) ABSTRACT

Provided are an anode active material for a lithium secondary battery, a manufacturing method of the anode active material, and a lithium secondary battery using the anode active material. More particularly, an anode active material for a lithium secondary battery having a high capacity and an excellent cycle lifetime, a manufacturing method of the anode active material, and a lithium secondary battery using the anode active material are provided. In the anode active material, monomers are coated on a tin nanopowder. The anode active material has a higher capacity and a higher cycle lifetime than a conventional anode active material.

### CROSS-REFERENCE TO RELATED PATENT APPLICATION

This application claims priority to and the benefit of Korean Patent Application No. 10-2005-0060301, filed on Jul. 5, 2005 in the Korean Intellectual Property Office, the entire disclosure of which is incorporated herein by reference.

### BACKGROUND OF THE INVENTION

1. Field of the Invention

The present invention relates to an anode active material, a manufacturing method thereof, and a lithium battery using the anode active material. More particularly, it relates to an anode active material having a high capacity and a long lifetime, a manufacturing method thereof, and a lithium battery using the anode active material.

2. Description of the Related Art

Lithium metal can be used as an anode active material. However, when lithium metal is used, dendrites are formed, causing a short-circuit in batteries, and sometimes even an explosion. Accordingly, carbon-based materials are widely used as anode active materials instead of lithium metal.

Examples of carbon-based active materials used as anode active materials in lithium batteries include crystalline-based carbon such as natural graphite and artificial graphite and amorphous-based carbon such as soft carbon and hard carbon. Amorphous-based carbon has excellent capacity, but irreversibility is a problem during a charge/discharge cycle. Natural graphite is the most commonly used crystalline-based carbon, and a theoretical maximum capacity thereof is high at 372 mAh/g. Therefore, crystalline-based carbon is widely used as an anode active material, but the lifetime thereof can be short.

However, since natural graphite and other carbon-based active materials have a capacity of only 380 mAh/g, they cannot be used in high-capacity lithium batteries.

In order to overcome this problem, metal-based anode active materials and intermetallic compound-based anode active materials have been actively researched. In particular, Sn, Si, and SnO₂ have twice the capacity of existing anode active materials, however, the irreversible capacity of existing SnO or SnO₂ based anode active materials is more than 65% of total capacity and the lifetime thereof is short. For example, SnO₂ has an initial discharge capacity of 1450 mAh/g but has an initial charge capacity of 650 mAh/g, and thus has low efficiency. Also, after 20 cycles, the ratio of the capacity to the initial capacity is less than 80%, and thus, it has a short lifetime. Accordingly, SnO₂ is seldom used in lithium secondary batteries.

In order to overcome such problems, Sn₂BPO₆ related complex oxides have been researched, but the capacity thereof also rapidly decreases. Also, the result of an electrochemical charge/discharge of a conventional nano Sn powder shows an initial capacity of less than 400 mAh/g, and a short lifetime.

### SUMMARY OF THE INVENTION

In one embodiment, the present invention provides an anode active material having high capacity and excellent cycle lifetime properties.

In another embodiment, the present invention provides a manufacturing method for an anode active material.

In yet another embodiment, the present invention provides a lithium battery having an improved anode active material.

According to an aspect of the present invention, there is provided an anode active material including a tin-based nanopowder in which a triazine-based monomer is capped.

In one embodiment, the tin-based nanopowder may be SnₓM₁₋ₓ where M is at least one element selected from the group consisting of Ge, Co, Te, Se, Ni, Co and Si, and x is a real number from 0.1 to 1.0.

In another embodiment, the particle size of the tin-based nanopowder is from about 10 to 300 nm.

In another embodiment, the tin-based nanopowder has a crystalline structure or an amorphous structure.

The triazine-based monomer may be a compound represented by Formula 1 or 2: 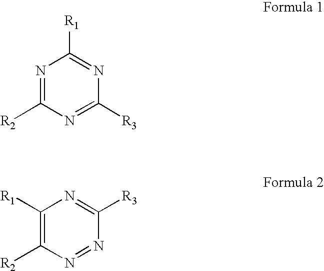
wherein each of R₁, R₂, and R₃ is independently hydrogen, a halogen, a carboxyl group, an amino group, a nitro group, a hydroxy group, a substituted or unsubstituted C₁₋₂₀ alkyl group, a substituted or unsubstituted C₁₋₂₀ heteroalkyl group, a substituted or unsubstituted C₂₋₂₀ alkenyl group, a substituted or unsubstituted C₂₋₂₀ heteroalkenyl group, a substituted or unsubstituted C₆₋₃₀ aryl group, or a substituted or unsubstituted C₃₋₃₀ heteroaryl group.

The triazine-based monomer is a compound represented by Formula 3 or 4:

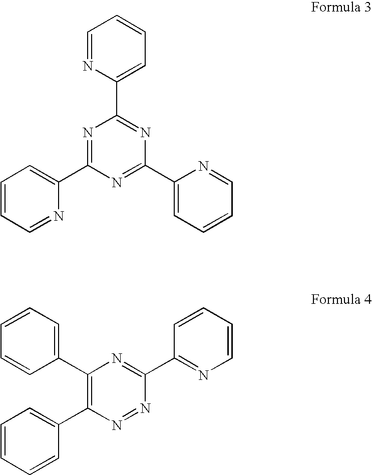

According to another aspect of the present invention, there is provided a method of manufacturing a tin-based anode active material including: dispersing a tin-based precursor with a dispersing agent in an organic solvent to obtain a first solution; mixing a triazine-based monomer with an organic solvent to obtain a second solution; mixing the first and second solutions and stirring the result to prepare a mixed solution; and reducing the mixed solution with a reducing agent in an inert atmosphere.

According to another aspect of the present invention, there is provided a lithium battery having the anode active material described above

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other features and advantages of the present invention will become more apparent by describing in detail exemplary embodiments thereof with reference to the attached drawings in which:

FIG. 1 is a schematic diagram illustrating the operating mechanism of an anode active material during a charge/discharge cycle according to the conventional art;

FIG. 2 shows transmission electron microscopy (TEM) images of Sn nanopowder obtained according to Examples 1 through 4 of the present invention;

FIG. 3 shows X-ray diffraction (XRD) patterns of the Sn nanopowder obtained according to Examples 1 through 4 of the present invention;

FIG. 4 shows charge/discharge curves of the Sn nanopowder obtained according to Examples 1 through 4 of the present invention;

FIG. 5 shows charge/discharge curves of the Sn nanopowder obtained according to Example 1 of the present invention;

FIG. 6 shows charge/discharge curves of Sn nanopowder obtained according to Comparative Example 1; and

FIG. 7 illustrates a battery according to an embodiment of the invention including an improved anode.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

An anode active material according to an embodiment of the present invention includes a tin-based nanopowder in which a triazine-based compound as a monomer is capped. The triazine-based monomer forms a capping layer on the tin-based nanopowder to form the nanopowder more easily and to decrease volume expansion of an active material in a charge/discharge cycle, thereby raising capacity.

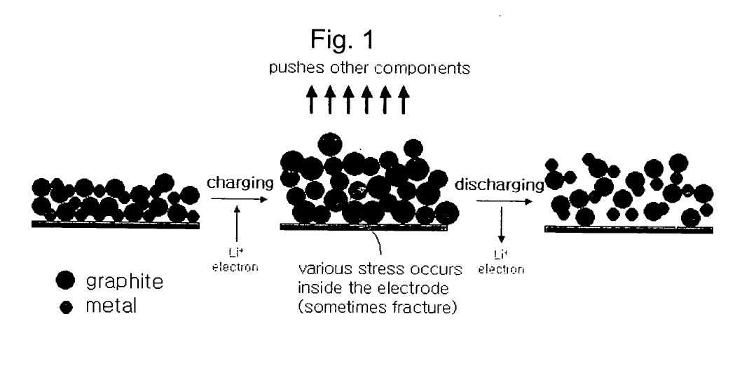

In general, an active material is repeatedly contracted and expanded during a charge/discharge cycle, and such volume changes cause irreversible electrical insulation. That is, as illustrated in FIG. 1, in a charging process, metals having greater volume expansion than carbon-based materials influence other components or even degrade due to expansion inside an electrode. Also, in a discharge process, complete restoration does not occur when the volume of the metals decreases, and thus, excessive spaces remain around the metal particles. Consequently, electrical insulation may occur between active materials. Such electrical insulation of the active materials causes a decrease in electric capacity, thereby reducing the performance of batteries.

In an embodiment of the present invention, a capping layer is introduced to decrease the absolute quantity of the volume expansion of the active materials during a charge/discharge cycle. A capping layer according to an embodiment of the present invention is used when preparing the active materials to form a nanopowder more easily and to decrease the absolute volume of the active material. Such a capping layer is distinguished from the form of ligand coordinate valence occurring around metals and is formed by simply intermixing capping materials in the metal particles. That is, when manufacturing the active materials, a monomer is chemically or physically bonded with metal particles or a monomer in a gap between powder particles or outer space thereof during forming nanopowder of the active materials and thus, the capping layer is formed. The formed capping layer suppresses agglomeration of the metal nanopowder and prevents damage to other components existing around the capping layer due to expansion during a charge cycle. Also, a restoration process of a discharge cycle is simple and electrical insulation is prevented, and thus, loss of electrical capacity is suppressed.

Triazine-based compounds can be used as the monomer to form the capping layer according to an embodiment of the present invention, and examples of triazine-based compounds that can be used include triazine-based compounds having substituents in location in Nos. 2, 4 and 6 of Formula 1 and triazine-based compounds having substituents in location in Nos. 3, 5 and 6 of Formula 2. 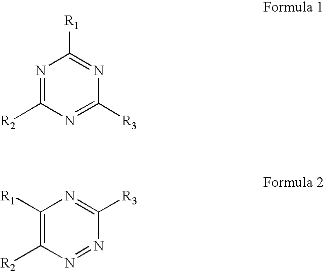
where each of R₁, R₂, and R₃ is independently hydrogen, a halogen, a carboxyl group, an amino group, a nitro group, a hydroxy group, a substituted or unsubstituted C₁₋₂₀ alkyl group, a substituted or unsubstituted C₁₋₂₀ heteroalkyl group, a substituted or unsubstituted C₂₋₂₀ alkenyl group, a substituted or unsubstituted C₂₋₂₀ heteroalkenyl group, a substituted or unsubstituted C₆₋₃₀ aryl group, or a substituted or unsubstituted C₆₋₃₀ heteroaryl group.

The alkyl group used as a substituent in the compound of the present embodiment may be a straight or branched radical having 1 to 20 carbon atoms, preferably 1 to 12 carbon atoms. More preferably, the alkyl radical is a lower alkyl having 1 to 6 carbon atoms. The alkyl group may be one of methyl, ethyl, n-propyl, isopropyl, n-butyl, isobutyl, sec-butyl, t-butyl, pentyl, iso-amyl, hexyl, etc. A lower alkyl radical having 1 to 3 carbon atoms can also be used.

The alkenyl group used as a substituent in the compound of the present embodiment may be a straight or branched C₂₋₂₀ aliphatic hydrocarbon group including a carbon-carbon double bond. The alkenyl group may have 2 to 12 carbon atoms, preferably, 2 to 6 carbon atoms. The branched alkenyl group includes at least one lower alkyl or alkenyl group attached to a straight alkenyl group. The alkenyl group may be unsubstituted or substituted by at least one group selected from the group consisting of halo, carboxy, hydroxy, formyl, sulfo, sulfino, carbamoyl, amino and imino. The alkenyl group may also be substituted by other groups. Examples of the alkenyl group include ethenyl, propenyl, carboxyethenyl, carboxypropenyl, sulfinoethenyl and sulfonoethenyl.

The aryl group used as a substituent in the compound of the present embodiment may be used alone or in a combination, and is a C₆₋₃₀ carbocyclic aromatic system including one or more rings. The rings may be attached or fused together using a pendent method. The term “aryl” includes aromatic radicals such as phenyl, naphthyl, tetrahydronaphthyl, indane and biphenyl. Preferably, the aryl is phenyl. The aryl group may be substituted by 1 to 3 groups selected from hydroxy, halo, haloalkyl, nitro, cyano, alkoxy, and lower alkylamino.

The heteroaryl group used as a substituent in the compound of the present embodiment is a C₆₋₂₀ monovalent monocyclic or bicyclic aromatic radical that has 1, 2 or 3 hetero atoms selected from N, O and S. For example, the heteroaryl group may be a monovalent monocyclic or bicyclic aromatic radical in which at least one of the hetero atoms is oxidized or quaternarized to form, for example, an N-oxide or a quaternary salt. Examples of the heteroaryl group include thienyl, benzothienyl, pyridyl, pyrazinyl, pyrimidinyl, pyridazinyl, quinolinyl, quinoxalinyl, imidazolyl, furanyl, benzofuranyl, thiazolyl, isoxazolyl, benzisoxazolyl, benzimidazolyl, triazolyl, pyrazolyl, pyrolyl, indolyl, 2-pyridonyl, 4-pyridonyl, N-alkyl-2-pyridonyl, pyrazinonyl, pyridazynonyl, pyrimidinonyl, oxazolonyl, corresponding N-oxides thereof (e.g., pyridyl N-oxide, quinolinyl N-oxide), and quaternary salts thereof, but are not limited thereto.

The heteroalkyl group used as a substituent in the compound of the present embodiment has 1 to 6 hetero atoms selected from N, O and S in the alkyl group defined above, and refers to the alkyl group having constituent atoms of the chain, C.

The heteroalkenyl group used as a substituent in the compound of the present embodiment has 1 to 6 hetero atoms selected from N, O and S in the alkenyl group defined above, and refers to the alkenyl group having constituent atoms of the chain, C.

The triazine-based monomer for Formula 1 may be one of the following:

(A) examples of 1,3,5-triazine-based monomers having a 2-pyridyl group:

2,4,6-tri(2-pyridyl)-1,3,5-triazine;

2,4,6-triphenyl-1 ,3,5-triazine;

2-(2-pyridyl)-4,6-diphenyl-1,3,5-triazine;

2,6-diphenyl-4-(2-pyridyl)-1,3,5-triazine;

2,4-diphenyl-6-(2-pyridyl)-1,3,5-triazine;

2-phenyl-4,6-di(2-pyridyl)-1,3,5-triazine;

2,6-di(2-pyridyl)-4-phenyl-1,3,5-triazine; and

2,4-di(2-pyridyl)-6-phenyl-1,3,5-triazine;

(B) examples of 1,2,4-triazine-based monomers having a 2-pyridyl group:

3,5,6-tri(2-pyridyl)-1,2,4-triazine;

3,5,6-triphenyl-1,2,4-triazine;

3-(2-pyridyl)-5,6-diphenyl-1,2,4-triazine;

3,6-diphenyl-5-(2-pyridyl)-1,2,4-triazine;

3,5-diphenyl-6-(2-pyridyl)-1,2,4-triazine;

3-phenyl-5,6-di(2-pyridyl)-1,2,4-triazine;

3,6-di(2-pyridyl)-5-phenyl-1,2,4-triazine; and

3,5-di(2-pyridyl)-6-phenyl-1,2,4-triazine;

(C) examples of 1,3,5-triazine-based monomers having a 3-pyridyl group:

2,4,6-tri(3-pyridyl)-1,3,5-triazine;

2,4,6-triphenyl-1 ,3,5-triazine;

2-(3-pyridyl)-4,6-diphenyl-1,3,5-triazine;

2,6-diphenyl-4-(3-pyridyl)-1,3,5-triazine;

2,4-diphenyl-6-(3-pyridyl)-1,3,5-triazine;

2-phenyl-4,6-di(3-pyridyl)-1,3,5-triazine;

2,6-di(3-pyridyl)-4-phenyl-1,3,5-triazine; and

2,4-di(3-pyridyl)-6-phenyl-1,3,5-triazine;

(D) examples of 1,2,4-triazine-based monomers having a 3-pyridyl group:

3,5,6-tri(3-pyridyl)-1,2,4-triazine;

3,5,6-triphenyl-1,2,4-triazine;

3-(3-pyridyl)-5,6-diphenyl-1,2,4-triazine;

3,6-diphenyl-5-(3-pyridyl)-1,2,4-triazine;

3,5-diphenyl-6-(3-pyridyl)-1,2,4-triazine;

3-phenyl-5,6-di(3-pyridyl)-1,2,4-triazine;

3,6-di(3-pyridyl)-5-phenyl-1,2,4-triazine; and

3,5-di(3-pyridyl)-6-phenyl-1,2,4-triazine;

(E) examples of 1,3,5-triazine-based monomers having a 4-pyridyl group:

2,4,6-tri(4-pyridyl)-1,3,5-triazine;

2,4,6-triphenyl-1,3,5-triazine;

2-(4-pyridyl)-4,6-diphenyl-1,3,5-triazine;

2,6-diphenyl-4-(4-pyridyl)-1,3,5-triazine;

2,4-diphenyl-6-(4-pyridyl)-1,3,5-triazine;

2-phenyl-4,6-di(4-pyridyl)-1,3,5-triazine;

2,6-di(4-pyridyl)-4-phenyl-1,3,5-triazine; and

2,4-di(4-pyridyl)-6-phenyl-1,3,5-triazine;

(F) examples of 1,2,4-triazine-based monomers having a 4-pyridyl group:

3,5,6-tri(4-pyridyl)-1,2,4-triazine;

3,5,6-triphenyl-1,2,4-triazine;

3-(4-pyridyl)-5,6-diphenyl- 1,2,4-triazine;

3,6-diphenyl-5-(4-pyridyl)-1,2,4-triazine;

3,5-diphenyl-6-(4-pyridyl)-1,2,4-triazine;

3-phenyl-5,6-di(4-pyridyl)-1,2,4-triazine;

3,6-di(4-pyridyl)-5-phenyl-1,2,4-triazine; and

3,5-di(4-pyridyl)-6-phenyl-1,2,4-triazine.

One or more hydrogen atoms included in the triazine-based monomers listed above can be substituted by hydroxy, a halogen, an amino group, a nitro group, a carboxyl group, a substituted or unsubstituted C₁₋₁₀ an alkyl group, a substituted or unsubstitdted C₁₋₁₀ heteroalkyl group, a substituted or unsubstituted C₂₋₂₀ alkenyl group, a substituted or unsubstituted C₂₋₂₀ heteroalkenyl group, a substituted or unsubstituted C₆₋₂₀ aryl group, or a substituted or unsubstituted C₃₋₂₀ heteroaryl group.

According to an embodiment of the present invention, the triazine-based monomer may be a 2,4,6-tri(2-pyridyl)-1,3,5-triazine-based monomer in Formula 3, or a 3-(2-pyridyl)-5,6-diphenyl-1,2,4-triazine-based monomer in Formula 4.

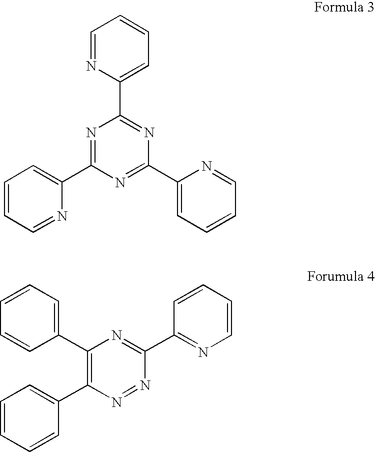

The tin-based nanopowder in which the triazine-based monomer forms the capping layer is not particularly restricted, and may be SnₓM₁₋ₓ where M is at least one element selected from the group consisting of Ge, Co, Te, Se, Ni, Co and Si and x is a real number from 0.1 to 1.0. Tin metal may be used as the tin-based nanopowder and preferably a metal compound is used to improve electric conductivity and decrease volume expansion caused by tin.

According to an embodiment of the present invention, the tin-based nanopowder may have a crystalline or amorphous structure.

Agglomeration of the tin-based nanopowder is suppressed, and thus becomes a nanopowder having a particle size of 10 to 300 nm. When the particle size of the tin-based nanopowder is greater than 300 nm, coarsening may occur during charge/discharge, and when the particle size of the tin-based nanopowder is less than 10 nm, an irreversible capacity increases due to an increase in a specific surface area.

The anode active material including the tin-based nanopowder capped with the triazine-based monomer is also a nanopowder, since agglomeration is suppressed by the capping layer. When anode active material is used to form an electrode, deterioration of the electrode is suppressed due to a decrease in absolute volume during a charge/discharge cycle, and thus a capacity decrease is prevented.

The anode active material including the tin-based nanopowder capped with the triazine-based monomer can be manufactured according the following process.

First, a first solution is obtained by dispersing a tin-based precursor with a dispersing agent in an organic solvent. A second solution is obtained by mixing a triazine-based monomer with an organic solvent. Then, the first and second solutions are mixed and stirred to prepare a mixed solution. The mixed solution is reduced with a reducing agent in an inert atmosphere and the anode active material including the tin-based nanopowder capped with the triazine-based monomer according to an embodiment of the present invention can be manufactured.

The tin-based precursor used in the above-descried process may be tin chloride, sodium stannate or hydrates thereof, and acts as the matrix of the anode active material including the tin-based nanopowder.

The organic solvent used in the above-described process is not restricted, and examples include dichloromethane, tetrahydro, furan, glyme, and diglyme.

The triazine-based monomer used in the above-described process may be one of various monomers, for example, the triazine-based monomers in Formula 1 or 2 or the triazine-based monomer listed in (A) through (F) above.

The reducing agent used in the above-described process can be any reducing agent, and examples include NaBH₄, KBH₄, LiBH₄, sodium hypophosphite or dimethylamine borane.

The triazine-based monomer in the above process forms the capping layer while suppressing agglomeration of the tin-based nanopowder. The formed capping layer reduces the absolute volume of the anode active material including the tin-based nanopowder, suppresses deterioration of electrode materials by minimizing volume changes due to charge/discharge, and prevents a decrease in capacity.

The anode active material including the tin-based nanopowder capped with the triazine-based monomer according to an embodiment of the present invention is useful for a lithium battery.

A lithium battery according to an embodiment of the present embodiment can be manufactured as follows.

First, a cathode active material, a conducting agent, a binder and a solvent are mixed to prepare a cathode active material composition. The cathode active material composition is directly coated on an Al current collector and dried to prepare a cathode plate. Alternatively, the cathode active material composition is cast on a separate substrate and a film obtained therefrom is laminated on an Al current collector to prepare a cathode plate.

The cathode active material is any lithium containing metal oxide that is commonly used in the art, and examples thereof include LiCoO₂, LiMnₓO₂ₓ, LiNi₁₋ₓMnₓO₂ₓ (where x=1 or 2), Ni_{1-x-y}CoₓMn_{y}O₂ (where 0≦x≦0.5 and 0≦y≦0.5), etc.

Carbon black may be used as the conducting agent. The binder may be vinylidene fluoride/hexafluoropropylene copolymer, polyvinylidene fluoride, polyacrylonitrile, polymethylmethacrylate, polytetrafluoroethylene, mixtures thereof, or a styrene butadiene rubber-based polymer. The solvent may be N-methylpyrrolidone, acetone, water, etc. The amounts of the cathode active material, the conducting agent, the binder and the solvent are those commonly used in a lithium battery.

Similarly, an anode active material, a conducting agent, a binder and a solvent are mixed to prepare an anode active material composition. The anode active material composition is directly coated on a Cu current collector, or is cast on a separate substrate and an anode active material film obtained therefrom is laminated on a Cu current collector to obtain an anode plate. The amounts of the anode active material, the conducting agent, the binder and the solvent are those commonly used in a lithium battery.

Lithium metal, a lithium alloy, a carbonaceous material or graphite is used as the anode active material. The conducting agent, the binder and the solvent in the anode active material composition are the same as those in the cathode active material composition. If desired, a plasticizer may be added to the cathode active material composition and the anode active material composition to produce pores inside the electrode plates.

A separator of the lithium battery may be composed of any material that is commonly used in a lithium battery. A material having a low resistance to the movement of ions of an electrolyte and a good ability to absorb an electrolytic solution is preferred. For example, the material may be a non-woven or woven fabric selected from the group consisting of glass fiber, polyester, Teflon, polyethylene, polypropylene, polytetrafluoroethylene (PTFE) and combinations thereof. More specifically, a lithium ion battery uses a windable separator composed of polyethylene, polypropylene, etc., and a lithium ion polymer battery uses a separator having an ability to impregnate an organic electrolytic solution. The separator may be prepared using the following method.

A polymer resin, filler and a solvent are mixed to prepare a separator composition. The separator composition is directly coated on an electrode and dried to form a separator film. Alternatively, the separator composition is cast on a substrate and dried, and then a separator film formed on the substrate is peeled off and laminated on an electrode.

The polymer resin is not particularly restricted and may be any material that is used in a conventional binder for an electrode plate. Examples of the polymer resin include a vinylidenefluoride/hexafluoropropylene copolymer, polyvinylidenefluoride, polyacrylonitrile, polymethylmethacrylate and a mixture thereof. In particular, a vinylidenefluoride/hexafluoropropylene copolymer containing 8 to 25% by weight of hexafluoropropylene can be used.

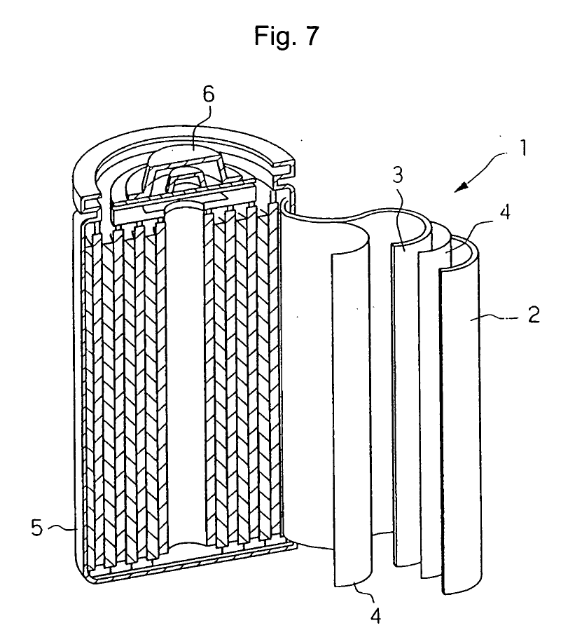

According to FIG. 7, a lithium battery of the present invention is illustrated. A separator 4 is interposed between a cathode plate 3 and an anode plate 2 to form a battery assembly 1. The battery assembly 1 is wound and placed in a cylindrical battery case 5. Then, the organic electrolytic solution is injected into the battery case and a cap 6 completes the lithium battery. Of course, in an alternate embodiment, rather than winding the battery assembly, the battery assembly is folded. Furthermore, in another embodiment, a rectangular battery case may be used.

The organic electrolytic solution includes a lithium salt and the mixed organic electrolytic solvent formed of a high dielectric constant solvent and a low boiling point solvent and, if necessary, further includes various additives such as for overcharge protection.

The high dielectric constant solvent used in the organic electrolytic solution is not particularly restricted and may be any such solvent that is commonly used in the art. Examples include, cyclic carbonates, such as ethylene carbonate, propylene carbonate, or butylene carbonate, y-butyrolactone, etc.

The low boiling point solvent can be any low boiling point solvent commonly used in the art. Examples include chain carbonates, such as dimethyl carbonate, ethylmethyl carbonate, diethyl carbonate, or dipropyl carbonate, dimethoxyethane, diethoxyethane, fatty acid ester derivatives, etc.

The volumetric ratio of the high dielectric constant solvent to the low boiling point solvent may be from 1:1 to 1:9. When the ratio is outside of this range, the discharge capacity and charge/discharge cycle life of the battery may degrade.

The lithium salt used in the organic electrolytic solution can be any lithium salt that is commonly used in a lithium battery. Examples include one or more compounds selected from the group consisting of LiClO₄, LiCF₃SO₃, LiPF₆, LiN(CF₃SO₂), LiBF₄, LiC(CF₃SO₂)₃ and LiN(C₂F₅SO₂)₂.

The concentration of the lithium salt in the organic electrolytic solution may be from 0.5 to 2 M. When the concentration of the lithium salt is less than 0.5 M, the conductivity of the electrolytic solution is low, thereby degrading the performance of the electrolytic solution. When the concentration of the lithium salt is greater than 2.0 M, the viscosity of the electrolytic solution increases, and thus the mobility of lithium ions is reduced.

The present invention will be described in greater detail with reference to the following examples. The following examples are for illustrative purposes and are not intended to limit the scope of the invention.

### EXAMPLE 1

In order to synthesize Sn nanopowder coated with 2,4,6-tri(2-pyridyl)-1,3,5-triazine, 0.7 ml of tetraacetyl ammoniumbromide was added to a mixed solution of 0.9 mmol of SnCl₄:5H₂O and 15 mL of CH₂Cl₂ to obtain a first solution. In addition, 4.8 mmol of 2,4,6-tri(2-pyridyl)-1,3,5-triazine was added to CH₂Cl₂ and stirred to obtain a second solution. The first and second solutions were mixed and stirred for 20 minutes. Then, 18 mmol of NaBH₄ was added as a reducing agent to the resulting mixture and stirred for 1 hour in an argon atmosphere. The Sn nanopowder capped with precipitated monomer was washed more than 3 times using water and acetone and then vacuum dried.

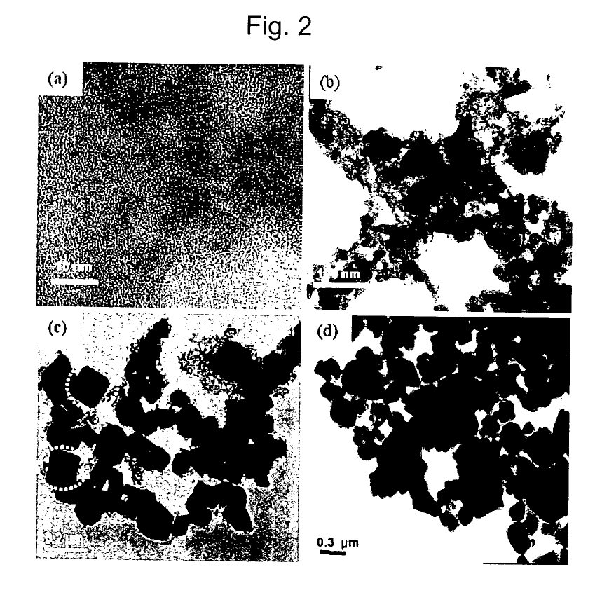

According to part (a) of FIG. 2, a transmission electron microscopy (TEM) image of the Sn nanopowder synthesized above is illustrated. Referring to FIG. 2, the average diameter of the tin-based nanopowder was 10 nm.

Then, 1 g of the tin-based nanopowder, 0.3 g of a polyvinylidene fluoride (PVDF, KF1100, Kureha Chemicals, Japan) as a binder, and 0.3 g of super P carbon black were added to a N-methylpyrrolidone (NMP) solution and coated on a copper foil (Cu foil) to prepare a plate. Li metal was used as the cathode to prepare a 2016-type coin cell using this plate and a charge/discharge cycle was performed 30 times between 1.2 and 0 V. The current density was 0.3 mA/cm2. As the electrolytic solution, ethylene carbonate (EC) in which 1.03 M of M LiPF6 was dissolved, diethylene carbonate (DEC) and a mixed solution of ethyl-methyl carbonate (EMC) (mixture ratio of 3:3:4) were used.

### EXAMPLE 2

A Sn nanopowder was manufactured in the same manner as in Example 1, except that 2.4 mmol of 2,4,6-tri(2-pyridyl)-1,3,5-triazine-based used as a capping agent.

Part (b) of FIG. 2 is a TEM image of the Sn nanopowder synthesized above according to Example 2. Referring to FIG. 2, the average diameter of the tin-based nanopowder was 20 nm.

Methods of manufacturing cells for electrochemical evaluation and evaluating the same were the same as in Example 1.

### EXAMPLE 3

Sn nanopowder was manufactured in the same manner as in Example 1, except that 4.8 mmol of 2,4,6-tri(2-pyridyl)-1,3,5-triazine-based was used as a capping agent.

Part (c) of FIG. 2 is a TEM image of the Sn nanopowder synthesized according to Example 3. Referring to FIG. 2, the average diameter of the tin-based nanopowder was 200 nm.

Methods of manufacturing cells for electrochemical evaluation and evaluating the same were the same as in Example 1.

### EXAMPLE 4

Sn nanopowder was manufactured in the same manner as in Example 1, except that 2.4 mmol of 2,4,6-tri(2-pyridyl)-1,3,5-triazine-based was used as a capping agent.

Part (d) of FIG. 2 is a TEM image of the Sn nanopowder synthesized according to Example 4. Referring to FIG. 2, the average diameter of the tin-based nanopowder was 300 nm.

Methods of manufacturing cells for electrochemical evaluation and evaluating the same were the same as in Example 1.

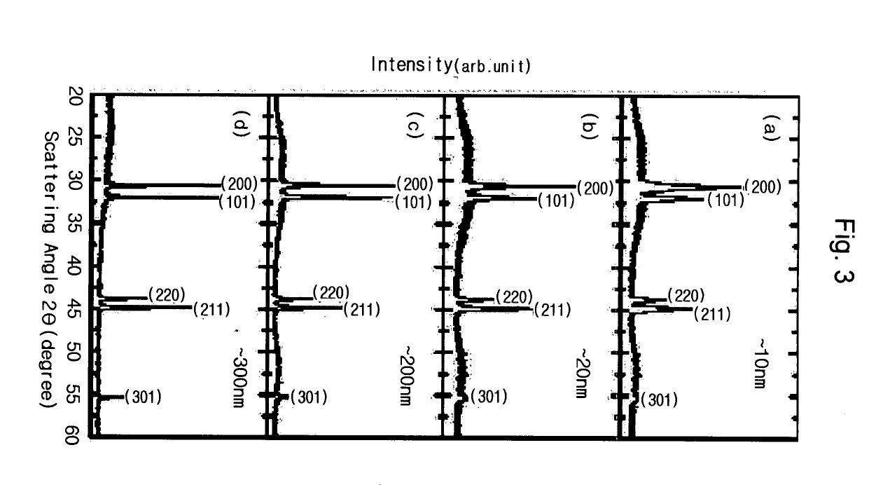

FIG. 3 is an X-ray diffraction (XRD) pattern of the Sn nanopowder synthesized in Examples 1 through 4 with parts (a) through (d) of FIG. 3 corresponding to Examples 1 through 4, respectively. Referring to FIG. 3, impurities were not found, and the particle size determined using the Scherrer equation (t=(0.9*λ)/(B*cosθ), where t=crystallite size, λ=wavelength, B=full width at half-maximum, θ=Bragg angle) is the same as the particle sized obtained from the TEM.

### COMPARATIVE EXAMPLE 1

1 g of SnCl₄ was melted in 50 ml of distilled water and 4 g of NaBH₄ were added to reduce the mixture to Sn nanopowder. Methods of manufacturing cells for electrochemical evaluation and evaluating the same were the same as in Example 1.

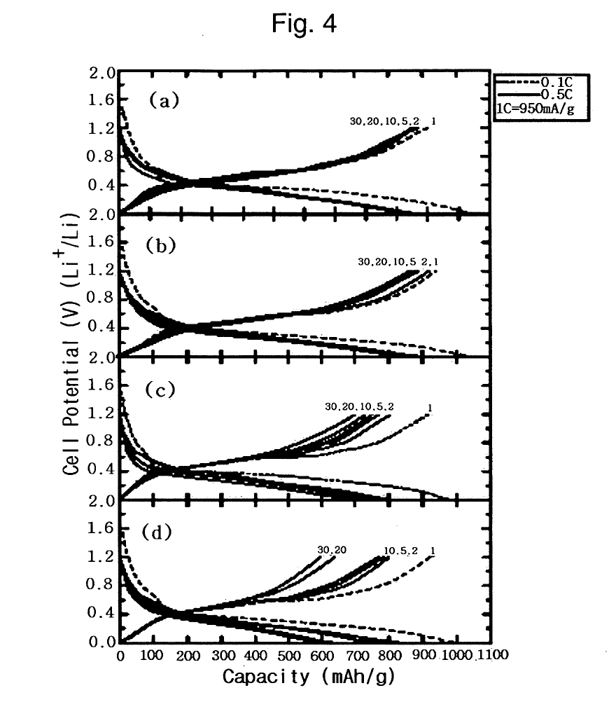

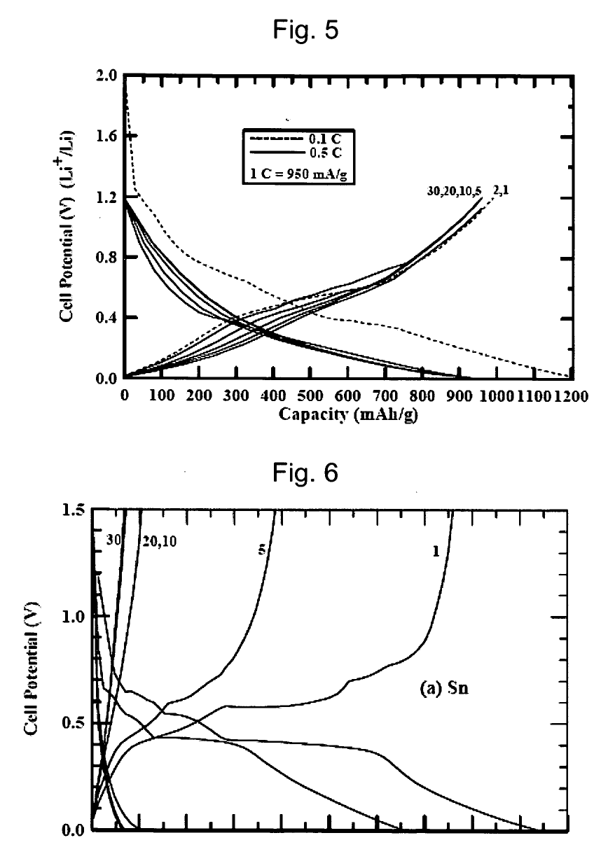

In Table 1, initial charge/discharge capacity, irreversible capacity, and capacity retention after 30 charge/discharge cycles are shown. FIG. 4 shows charge/discharge curves of the Sn nanopowder obtained according to Examples 1 through 4 of the present invention with parts (a) through (d) of FIG. 4 corresponding to Examples 1 through 4, respectively. FIGS. 5 and 6 are graphs of charge/discharge curves of the Sn nanopowder synthesized according to Examples 1 and Comparative Example 1. From the results, it can be seen that the Sn nanopowder in which the monomer is capped on the surface thereof has an improved capacity and lifetime. Also, when an oleic acid is used as a capping agent, an amorphous type Sn nanopowder is produced, and when 2,4,6-tri(2-pyridyl)-1,3,5-triazine or 3-(2-pyridyl)-5,6-diphenyl-1,2,4-triazine is used, the particle size of the Sn nanopowder, which has a crystalline structure, is 10 nm to 300 nm according to a molar ratio of the monomer.

TABLE 1

| | Initial | Initial | | |
|---|---|---|---|---|
| | discharge | charge | Irreversible | Charged capacity |
| | capacity | capacity | capacity | after 30 cycles |
| | (mAh/g) | (mAh/g) | (mAh/g) | (mAh/g) |
| Example 1 | 1150 | 1000 | 115 | 950 |
| Example 2 | 1050 | 940 | 110 | 865 |
| Example 3 | 984 | 916 | 68 | 700 |
| Example 4 | 997 | 919 | 78 | 700 |
| Comparative | 950 | 750 | 200 | 67 |
| Example 1 | | | | |

As shown in Table 1 and FIG. 4, the anode active material according to Examples 1 through 4 of the present invention has a high initial discharge capacity, a low irreversible capacity, and low discharge capacity reduction even after 30 charge/discharge cycles.

The anode active material of the present invention forms the capping layer in the tin-based nanopowder and in a manufacturing process of tin-based nanopowder, the anode active material facilitates the forming of the tin-based nanopowder. Also, the capping layer reduces the absolute volume of the active material that occurs in a charge/discharge cycle to increase capacity, and is useful for lithium batteries due to its high capacity and excellent cycle lifetime.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An anode active material comprising a tin-based nanopowder and a triazine-based monomer that is capped.

2. The anode active material of claim 1, wherein the tin-based nanopowder comprises SnₓM₁₋ₓ, where M is an element selected from the group consisting of Ge, Co, Te, Se, Ni, Co, Si, and combinations thereof, and x is from 0.1 to 1.0.

3. The anode active material of claim 1, wherein the particle size of the tin-based nanopowder is from about 10 to 300 nm.

4. The anode active material of claim 1, wherein the tin-based nanopowder has a crystalline structure or an amorphous structure.

5. The anode active material of claim 1, wherein the triazine-based monomer is a compound represented by Formula 1 or 2: 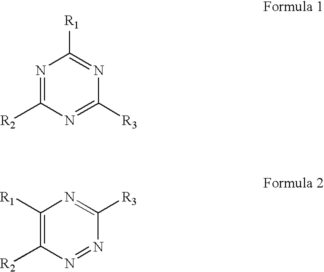
where each of R₁, R₂, and R₃ is independently selected from the group consisting of hydrogen, halogens, a carboxyl group, an amino group, a nitro group, a hydroxy group, substituted or unsubstituted C₁₋₂₀ alkyl groups, substituted or unsubstituted C₁₋₂₀ heteroalkyl groups, substituted or unsubstituted C₂₋₂₀ alkenyl groups, substituted or unsubstituted C₂₋₂₀ heteroalkenyl groups, substituted or unsubstituted C₆₋₃₀ aryl groups, and substituted or unsubstituted C₃₋₃₀ heteroaryl groups.

6. The anode active material of claim 1, wherein the triazine-based monomer is a compound represented by Formula 3 or 4:

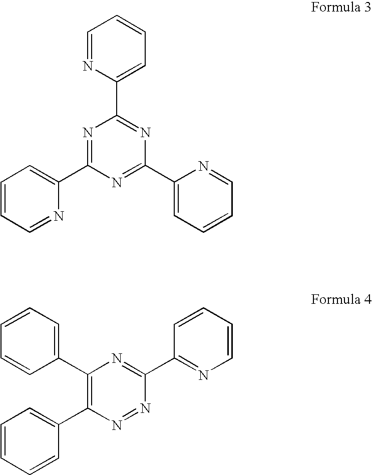

7. A method of manufacturing a tin-based anode active material comprising:
dispersing a tin-based precursor with a dispersing agent in an organic solvent to obtain a first solution;
mixing a triazine-based monomer with an organic solvent to obtain a second solution;
mixing the first and second solutions to prepare a mixed solution; and
reducing the mixed solution with a reducing agent in an inert atmosphere.

8. The method of claim 7, wherein the tin-based nanopowder is SnₓM₁₋ₓ, where M is an element selected from the group consisting of Ge, Co, Te, Se, Ni, Co, Si, and combinations thereof, and x is from 0.1 to 1.0.

9. The method of claim 7, wherein the triazine-based monomer is a compound represented by Formula 1 or 2: 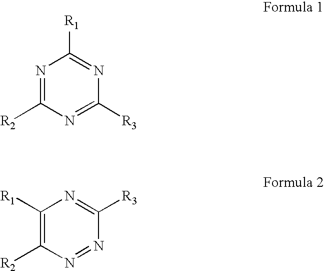
where each of R₁, R₂, and R₃ is independently selected from the group consisting of hydrogen, halogens, a carboxyl group, an amino group, a nitro group, a hydroxy group, substituted or unsubstituted C₁₂₀ alkyl groups, substituted or unsubstituted C₁₋₂₀ heteroalkyl groups, substituted or unsubstituted C₂₋₂₀ alkenyl groups, substituted or unsubstituted C₂₋₂₀ heteroalkenyl groups, substituted or unsubstituted C₆₋₃₀ aryl groups, and substituted or unsubstituted C₃₋₃₀ heteroaryl groups.

10. The method of claim 7, wherein the triazine-based monomer is a compound represented by Formula 3 or 4:

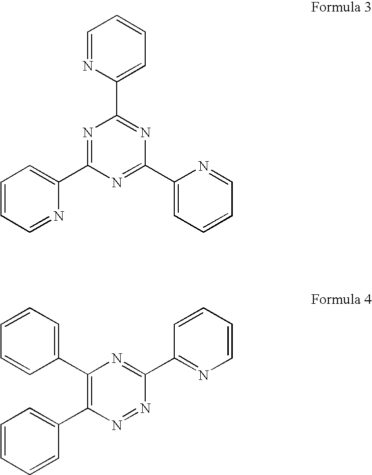

11. A lithium battery comprising an anode and a cathode, wherein the anode comprises an anode active material comprising a tin-based nanopowder and a triazine-based monomer that is capped.

12. The lithium battery of claim 11, wherein the tin-based nanopowder comprises SnₓM₁₋ₓ, where M is an element selected from the group consisting of Ge, Co, Te, Se, Ni, Co, Si, and combinations thereof, and x is from 0.1 to 1.0.

13. The lithium battery of claim 11, wherein the particle size of the tin-based nanopowder is from about 10 to 300 nm.

14. The lithium battery of claim 11, wherein the tin-based nanopowder has a crystalline structure or an amorphous structure.

15. The lithium battery of claim 11, wherein the triazine-based monomer is a compound represented by Formula 1 or 2: 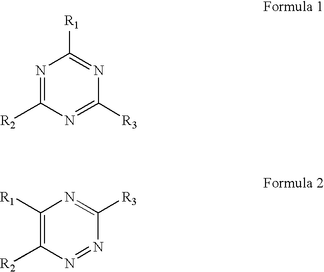
where each of R₁, R₂, and R₃ is independently selected from the group consisting of hydrogen, halogens, a carboxyl group, an amino group, a nitro group, a hydroxy group, substituted or unsubstituted C₁₋₂₀ alkyl groups, substituted or unsubstituted C₁₋₂₀ heteroalkyl groups, substituted or unsubstituted C₂₋₂₀ alkenyl groups, substituted or unsubstituted C₂₋₂₀ heteroalkenyl groups, substituted or unsubstituted C₆₋₃₀ aryl groups, and substituted or unsubstituted C₃₋₃₀ heteroaryl groups.

16. The lithium battery of claim 11, wherein the triazine-based monomer is a compound represented by Formula 3 or 4: [chemical structure]
